(19) United States
(12) Patent Application Publication
(10) Pub. No.: US 2021/0296745 A1
(43) Pub. Date: Sep. 23, 2021

(54) BATTERY PACK PRODUCTION METHOD AND BATTERY PACK

(71) Applicant: TOYOTA JIDOSHA KABUSHIKI KAISHA, Toyota-shi (JP)

(72) Inventors: Kenichiro NAKASHIMA, Toyota-shi (JP); Yasumasa OGUMA, Toyota-shi (JP)

(21) Appl. No.: 17/197,149

(22) Filed: Mar. 10, 2021

(30) Foreign Application Priority Data
Mar. 23, 2020 (JP) 2020-051801

(51) Int. Cl. H01M 50/578; H01M 50/59

(52) U.S. Cl. CPC H01M 50/578; H01M 50/59

(57) ABSTRACT

The battery pack production method of the present disclosure comprises the steps of: arranging a first intervening member between a first member and a second member, wherein the first member is a first battery, the first battery has a first battery exterior body and an electrode body arranged in an interior of the first battery exterior body, the second member is a retention member or a second battery, the second battery has a second battery exterior body and an electrode body arranged in an interior of the second battery exterior body; and while one end of the first intervening member is brought into contact with a pressing member, inserting a tapered member between the first intervening member and the second member from an opposite end side of the first intervening member to press the first intervening member toward the first member and exert a restraining pressure on the first member. According to the production method of the present disclosure, when the tapered member is inserted to exert the restraining pressure on the battery, the occurrence of scratches in the battery exterior body and damage to the battery exterior body due to the sliding of the tapered member can be prevented.

### FIELD

The present disclosure relates to a battery pack production method and a battery pack.

### BACKGROUND

Patent Literature 1 discloses a technology in which after a plurality of battery modules are stored in a housing, wedge members are inserted between the battery modules and the inner wall of the housing to exert pressure on the plurality of battery modules (refer to FIG. 10 of Patent Literature 1). Furthermore, Patent Literature 2 discloses a technology in which wedge-shaped spacers are inserted between a plurality of rectangular batteries arranged in a radial pattern, and the spacers are pressed inward to exert pressure on each of the rectangular batteries.

### CITATION LIST

### Patent Literature

[PTL 1] Japanese Patent No. 5288853

[PTL 2] Japanese Unexamined Patent Publication No. 2008-293662

### SUMMARY

### Technical Problem

In the technologies disclosed in Patent Literature 1 and 2, it is necessary to slide the wedge members on the surfaces of the exterior bodies of the batteries in order to exert pressure on the batteries. Thus, the dynamic friction between the exterior bodies of the batteries and the wedge members may cause scratches on the surfaces of the exterior bodies of the batteries or damage the exterior bodies of the batteries.

### Solution to Problem

As one means for solving the above problem, the present disclosure provides:

a production method for a battery pack, comprising

arranging a first intervening member between a first member and a second member, wherein the first member is a first battery, the first battery comprises a first battery exterior body and an electrode body arranged in an interior of the first battery exterior body, the second member is a retention member or a second battery, the second battery comprises a second battery exterior body and an electrode body arranged in an interior of the second battery exterior body, and

while one end of the first intervening member is brought into contact with a pressing member, inserting a tapered member between the first intervening member and the second member from an opposite end side of the first intervening member to press the first intervening member toward the first member and exert a restraining pressure on the first member.

The production method of the present disclosure may comprise:

arranging the first intervening member and a second intervening member between the first member and the second member, and

while pressing one end of the first intervening member and one end of the second intervening member with at least one pressing member, inserting the tapered member between the first intervening member and the second intervening member from an opposite side of the first intervening member and an opposite side of the second intervening member to press the first intervening member toward the first member and press the second intervening member toward the second member to exert a restraining pressure on the first member and the second member.

In the production method of the present disclosure,

the second member may be the retention member,

a concave/convex guide may be provided between the second member and the tapered member, and

the tapered member may be inserted along the concave/convex guide.

In the production method of the present disclosure:

a concave/convex guide may be provided between the first intervening member and the tapered member, and

the tapered member may be inserted along the concave/convex guide.

In the production method of the present disclosure:

the coefficient of friction between the first intervening member and the tapered member may be less than the coefficient of friction between the first battery exterior body and the first intervening member.

The production method of the present disclosure may comprise:

arranging the first member, the second member, and the first intervening member inside an annular restraining member, and

pressing the first member and the second member toward an inner surface of the restraining member by insertion of the tapered member.

In the production method of the present disclosure,

the first battery and the second battery may be solid-state batteries.

As one means for solving the above problem, the present disclosure provides:

a battery pack, comprising a first member, a second member, a first intervening member, and a tapered member, wherein

the first member is a first battery,

the first battery comprises a first battery exterior body and an electrode body arranged in an interior of the first battery exterior body,

the second member is a retention member or a second battery,

the second battery comprises a second battery exterior body and an electrode body arranged in an interior of the second battery exterior body,

the first intervening member is arranged between the first member and the second member,

the tapered member is arranged between the first intervening member and the second member, and

the tapered member contacts the first intervening member, and a restraining pressure is exerted onto the first member from the tapered member via the first intervening member.

In the battery pack of the present disclosure,

the first intervening member and a second intervening member may be arranged between the first member and the second member,

the tapered member may be arranged between the first intervening member and the second intervening member, and

the tapered member may contact the first intervening member and the second intervening member, a restraining pressure may be exerted onto the first member from the tapered member via the first intervening member, and a restraining pressure may be exerted onto the second member from the tapered member via the second intervening member.

In the battery pack of the present disclosure,

the second member may be the retention member, and

a concave/convex guide may be provided between the second member and the tapered member.

In the battery pack of the present disclosure,

a concave/convex guide may be provided between the first intervening member and the tapered member.

In the battery pack of the present disclosure,

the coefficient of friction between the first intervening member and the tapered member may be less than the coefficient of friction between the first battery exterior body and the first intervening member.

The battery pack of the present disclosure may comprise:

an annular restraining member, wherein

the first member, the second member, and the first intervening member may be arranged inside the restraining member, and

the first member and the second member may be pressed toward an inner surface of the restraining member.

In the battery pack of the present disclosure,

the first battery and the second battery may be solid-state batteries.

### Advantageous Effects of Invention

According to the technology of the present disclosure, when the tapered member is inserted, the tapered member does not directly contact the battery exterior body. Thus, the occurrence of scratches in the battery exterior body and damage to the battery exterior body due to the sliding of the tapered member can be prevented.

### BRIEF DESCRIPTION OF DRAWINGS

FIG. 1A is a schematic view detailing an example of a step of the battery pack production method.

FIG. 1B is a schematic view detailing an example of a step of the battery pack production method.

FIG. 1C is a schematic view detailing an example of a step of the battery pack production method.

FIG. 2A is a schematic view detailing a concave/convex guide.

FIG. 2B is a schematic view detailing a concave/convex guide. The end surface shape of the cross-section taken along arrow IIB-IIB in FIG. 2A is schematically illustrated.

FIG. 2C is a schematic view detailing a concave/convex guide. The end surface shape of the cross-section taken along arrow IIC-IIC in FIG. 2A is schematically illustrated.

FIG. 3A is a schematic view detailing an example of the structure of the battery pack.

FIG. 3B is a schematic view detailing an example of the structure of the battery pack.

FIG. 3C is a schematic view detailing an example of the structure of the battery pack.

FIG. 4A is a schematic view illustrating an example of a step of the battery pack production method.

FIG. 4B is a schematic view illustrating an example of a step of the battery pack production method.

FIG. 4C is a schematic view illustrating an example of a step of the battery pack production method.

FIG. 5A is a schematic view detailing a concave/convex guide.

FIG. 5B is a schematic view detailing a concave/convex guide. An end surface shape of the cross-section taken along arrow VB-VB of FIG. 5A is schematically illustrated.

FIG. 5C is a schematic view detailing a concave/convex guide. An end surface shape of the cross-section taken along arrow VC-VC of FIG. 5A is schematically illustrated.

FIG. 6A is a schematic view detailing an example of the structure of the battery pack.

FIG. 6B is a schematic view detailing an example of the structure of the battery pack.

FIG. 6C is a schematic view detailing an example of the structure of the battery pack.

### DESCRIPTION OF EMBODIMENTS

### 1. First Aspect

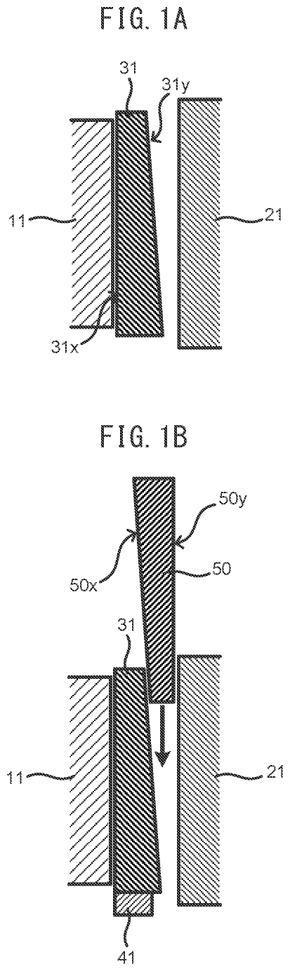

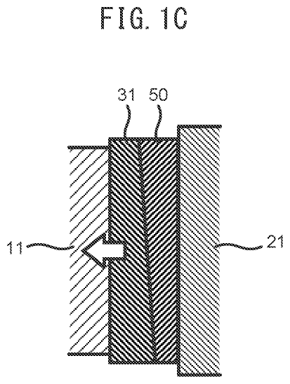

FIGS. 1A to C illustrate examples of the battery pack production method according to a first aspect. As shown in FIG. 1A, the production method comprises arranging a first intervening member 31 between a first member 11 and a second member 21. The first member 11 is a first battery 11, and the first battery 11 comprises a first battery exterior body and an electrode body arranged in the interior of the first battery exterior body. Furthermore, the second member is a retention member. As shown in FIGS. 1B and C, the production method includes, while one end of the first intervening member 31 is brought into contact with a pressing member 41, inserting a tapered member 50 between the first intervening member 31 and the second member 21 from an opposite end side of the first intervening member 31 to press the first intervening member 31 toward the first member 11 and exert a restraining pressure on the first member 11.

### 1.1 First Member

The first member 11 is the first battery 11, and the first battery 11 comprises a first battery exterior body and an electrode body arranged in the interior of the first battery exterior body. Though the first battery 11 may be a primary battery or may be a secondary battery which is capable of repeated charging and discharging, particularly in the case of a secondary battery, a significant effect can be brought about by the production method of the present disclosure. The first battery 11 may comprise a plurality of battery exterior bodies and electrode bodies each arranged in the interior of each of the battery exterior bodies. When the first battery 11 comprises a plurality of battery exterior bodies, among the plurality of battery exterior bodies, the battery exterior body adjacent to the intervening member 31 corresponds to the “first battery exterior body” described above. Furthermore, when the battery 11 comprises a plurality of battery exterior bodies, the plurality of battery exterior bodies may be stacked on each other and arranged in a uniaxial direction. The uniaxial direction may match the arrangement direction (stacking direction) of the first member 11, the first intervening member 31, the tapered member 50, and the second member 21, or may match the direction in which the restraining pressure is exerted on the first member 11.

As the first battery exterior body, bodies which are well known as the exterior body of a battery can be used. The first battery exterior body may be a laminate film in which a metal foil and a resin film are laminated, or may be a housing such as a metal case. In particular, when the first battery exterior body is a laminate film, restraining pressure can be easily exerted on the electrode body in the exterior body. When the first battery exterior body is a laminate film, the electrode body can be housed within the laminate film by, for example, covering the electrode body with one or a plurality of laminate films and sealing the laminate films.

As long as the electrode body is capable of generating a battery reaction, it can be composed of any well-known battery material. The structure of the electrode body may differ depending on the type of the first battery 11. For example, when the first battery 11 is a solid-state battery, the electrode body can comprise a positive electrode layer, a negative electrode layer, and a solid electrolyte layer arranged between the positive electrode layer and the negative electrode layer. Furthermore, when the first battery 11 is a liquid electrolyte battery, the electrode body can comprise a positive electrode layer, a negative electrode layer, and a separator layer arranged between the positive electrode layer and the negative electrode layer, and the positive electrode layer, the negative electrode layer, and the separator layer can be impregnated with liquid electrolyte. In the production method of the present disclosure, when the first battery 11 is a solid-state battery, the first member 11 being the solid state battery is pressed by the tapered member 50 via the first intervening member 31 and a restraining pressure is exerted on the solid-state battery, whereby the contact resistance of the electrode body can be reduced, and gaps caused by the expansion and contraction of the active material during charging and discharging can be eliminated. In order for the solid-state battery to function efficiently, it is necessary that a restraining pressure be applied to the electrode body, even during discharging. Thus, the technology of the present disclosure, in which a large compressive load can be applied from the time of assembly of the battery until after assembly of the battery, is extremely effective. In the prior art, when attempting to increasing the restraining pressure on the battery, there are concerns regarding damage to the battery exterior body due to friction between the wedge member and the battery exterior body, whereas in the production method of the present disclosure, an intervening member is arranged between the tapered member and the battery exterior body, whereby damage to the battery exterior body is unlikely to occur.

The number of electrode bodies to be arranged in the first battery exterior body is not particularly limited, and one or a plurality of electrode bodies may be arranged. In other words, the first battery 11 may be a laminated battery in which a plurality of electrode bodies are laminated in the interior of the first battery exterior body, or may be a unit cell in which only a single electrode body is arranged in the first battery exterior body. The effect of the production method of the present disclosure can be highly exhibited particularly in the case of a laminated battery. When the first battery 11 is a laminated battery, the lamination direction of the plurality of electrode bodies may match the above-mentioned uniaxial direction.

Though the orientation of the electrode body in the interior of the first battery exterior body is not particularly limited, when the lamination direction of each layer (positive electrode layer, negative electrode layer, electrolyte layer) of the electrode body and the direction of the restraining pressure match, the effect of reducing contact resistance and eliminating gaps described above is enhanced. In other words, the lamination direction of each layer of the electrode body may be match the above-mentioned uniaxial direction.

The first battery 11 may comprise, in addition to the electrode body described above, current collector tabs, terminals, and etc. as in conventional batteries.

### 1.2 Second Member

In the battery pack according to the first aspect, the second member 21 is a retention member 21. The retention member 21 may be a member which is capable of affixing and holding the relative positional relationship between the members (for example, the tapered member 50) which come into contact with the retention member 21 in the battery pack obtained by inserting the tapered member 50. The retention member 21 may be, for example, an end plate. Alternatively, the retention member 21 may be a battery pack case. When the retention member 21 is an end plate, a restraining member 60, which is described later, may be arranged on the side opposite the side in which the tapered member 50 and the intervening member 31 are arranged, using the end plate as a reference. When the end plate presses the restraining member 60, the surface of the end plate which comes into contact with the restraining member 60 is composed of curved surfaces, whereby stress concentration due to pressure fluctuations can be suppressed. Conversely, when the retention member 21 is a battery pack case, since the battery pack case can also function as a restraining member, the restraining member 60, which is described later, can be omitted. Note that as shown in FIG. 1C, the second member 21 and the tapered member 50 may surface-contact, or alternatively, an intervening member may be arranged between the second member 21 and the tapered member 50.

### 1.3 Intervening Member

As shown in FIG. 1A, in the production method of the present disclosure, the first intervening member 31 is arranged between the first member 11 and the second member 21, as described above. The first intervening member 31 is a member which is for preventing contact between the first member 11 and the tapered member 50. In the production method of the present disclosure, while sliding the tapered member 50 on the surface of the first intervening member 31, the tapered member 50 is inserted between the first intervening member 31 and the second member 21, whereby the tapered member 50 presses the first intervening member 31 and the first intervening member 31 is pressed toward the first member 11. The first intervening member may be, for example, a plate-like member. As shown in FIG. 1A, the first intervening member 31 may have a first surface 31x which surface-contacts the first member 11 and a second surface 31y which surface-contacts the tapered member 50. In this case, the shapes of the first surface 31x and the second surface 31y of the first intervening member 31 can be determined in accordance with the surface shape of the battery exterior body of the first member 11 and the tapered shape of the tapered member 50. For example, as shown in FIGS. 1A to C, the second surface 31y of the first intervening member 31 may have an inclined surface which intersects the uniaxial direction described above and which is not orthogonal to the uniaxial direction, and the inclined surface may have an inclination corresponding to the tapered shape of the tapered member 50.

The material of the first intervening member 31 is not particularly limited. For example, it can be composed of metal or ceramic. In particular, when the first intervening member 31 is made of metal, it is easier to suppress damage to the first intervening member 31.

### 1.4 Pressing Member (Holding Member/Contact Member)

As shown in FIG. 1B, in the production method of the present disclosure, while one end of the first intervening member 31 is brought into contact with the pressing member 41, a tapered member 50 is inserted between the first intervening member 31 and the second member 21 from the other end side of the first intervening member 31. As shown in FIG. 1B, the “one end of the intervening member” may be the tip in the insertion direction of the tapered member 50, and the “other end of the intervening member” may be the base end (the end on the side opposite the tip) in the insertion direction of the tapered member 50. The pressing member 41 may press the first intervening member 31 in the direction opposite the insertion direction of the tapered member 50 when the tapered member 50 is inserted. By inserting a tapered member 50 between the first intervening member 31 and the second member 21 from the other end side of the first intervening member 31 while the end of the first intervening member 31 is brought into contact with the pressing member 41 in this manner, during insertion of the tapered member 50, the pressing member 41 can hold the first intervening member 31 in the insertion direction of the tapered member 50, i.e., the first intervening member 31 can be affixed in the insertion direction of the tapered member 50, and for example, shifting or sliding of the first intervening member 31 with respect to the first member 11 can be prevented. Needless to say, even if the end of the first intervening member 31 comes into contact with the pressing member 41, the first intervening member 31 can slide in the uniaxial direction on the contact surface between the first intervening member 31 and the pressing member 41, and the first intervening member 31 can be pressed toward the first member 11.

Though FIG. 1B illustrates an aspect in which the pressing member 41 contacts only the first intervening member 31 during insertion of the tapered member 50, the pressing member may contact, in addition to the first intervening member 31, other members such as the first member 11 or the second member 21. Furthermore, when insertion of the tapered member 50 is complete, the tip of the tapered member may contact the pressing member 41. Furthermore, insertion of the tapered member 50 may be prevented by contact of the tip of the tapered member 50 with the pressing member 41.

Though FIG. 1B illustrates an aspect in which only one pressing member 41 is provided during insertion of the tapered member 50, a plurality of pressing members 41 may be arranged.

As shown in FIG. 1C, after insertion of the tapered member 50 has completed, the pressing member 41 may not constitute the battery pack. In other words, the pressing member 41 may be some sort of member on the production equipment side. For example, the pressing member 41 may be a jig which is separate from the battery pack.

### 1.5 Tapered Member

As shown in FIG. 1C, in the production method of the present disclosure, by inserting the tapered member 50 between the first intervening member 31 and the second member 21, the first intervening member 31 is pressed toward the first member 11, whereby a restraining pressure is exerted on the first member 11. As shown in FIGS. 1B and C, the tapered member 50 may have a shape which is tapered toward the insertion direction in cross-sectional shape along the insertion direction and along the arrangement direction of each member (first member 11, first intervening member 31, tapered member 50, and second member 21). As a result, the tapered member 50 can be inserted, whereby the intervening member 31 is pressed toward the first member 11. As the tapered member 50, for example, a plate-like member in which the cross-sectional shape in the thickness direction is tapered can be used. As shown in FIGS. 1B and C, the tapered member 50 may have a third surface 50x which surface-contacts the first intervening member 31 and a fourth surface 50y on the side opposite the third surface 50x. Though the third surface 50x and the fourth surface 50y of the tapered member 50 may be planar, may be curved, or may be a combination of planar and curved, in particular when the surfaces are planar, the insertion of the tapered member 50 becomes smoother, whereby the first intervening member 31 can be more easily pressed toward the first member 11.

The material of the tapered member 50 is not particularly limited. For example, it may be composed of metal or ceramic. In particular when the tapered member 50 is metal, damage to the tapered member can be more easily suppressed.

In the production method of the present disclosure, when the coefficient of friction between the first intervening member 31 and the tapered member 50 is less than the coefficient of friction between the first battery exterior body of the first battery 11 and the first intervening member 31, the insertion of the tapered member becomes smoother, whereby displacement or sliding of the first intervening member 31 with respect to the first member 11 can be more easily prevented. The coefficient of friction is the coefficient of friction of the frictional surfaces when the same load is applied. In the production method of the present disclosure, the static friction coefficient between the first intervening member 31 and the tapered member 50 may be less than the static friction coefficient between the first battery exterior body and the first intervening member 31, and the dynamic friction coefficient between the first intervening member 31 and the tapered member 50 may be less than the dynamic friction coefficient between the first battery exterior body and the first intervening member 31. The method for making the coefficient of friction between the first intervening member 31 and the tapered member 50 less than the coefficient of friction between the first battery exterior body and the first intervening member 31 is not particularly limited. For example, the coefficient of friction between the first intervening member 31 and the tapered member 50 may be reduced by polishing the contact surfaces of the first intervening member 31 and the tapered member 50. Alternatively, the coefficient of friction between the first battery exterior body and the first intervening member 31 may be increased by providing concavities and convexities on the contact surface between the first battery exterior body and the first intervening member 31. Alternatively, by fitting the first battery exterior body into the first intervening member 31, the relative positional relationship between the first battery exterior body and the first intervening member 31 may be fixed with respect to the insertion direction of the tapered member 50 (in this case, the coefficient of friction between the first battery exterior body and the first intervening member 31 can be infinitely large).

### 1.6 Other Members

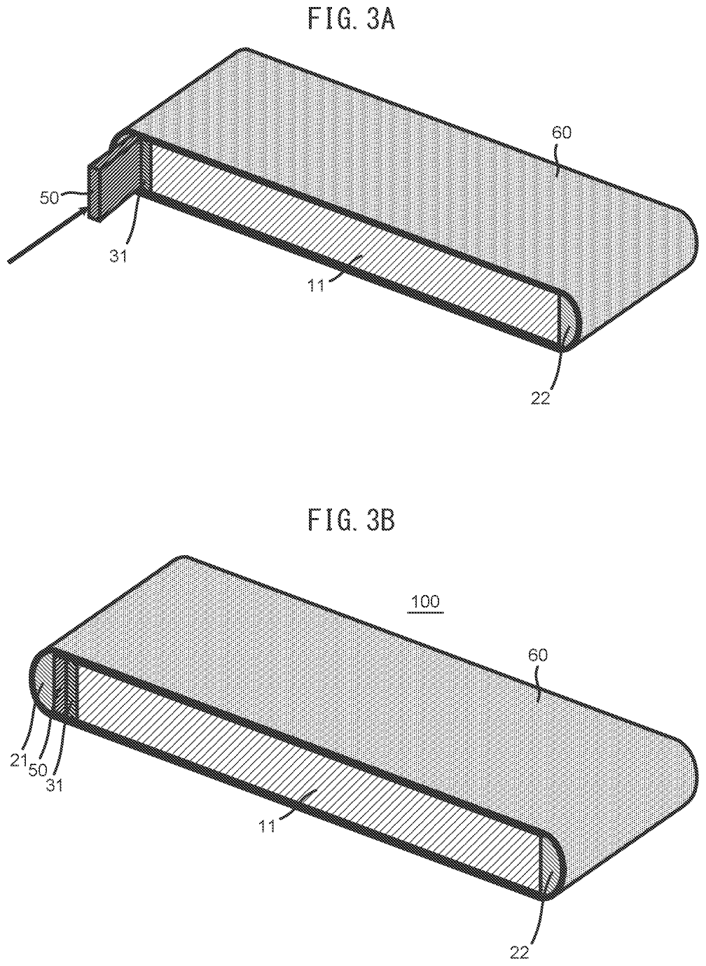

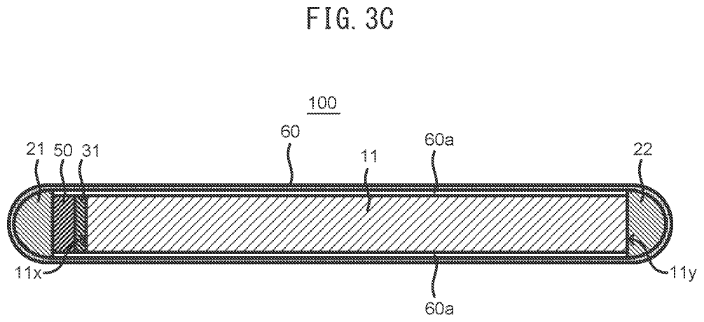

In the production method of the present disclosure, the first intervening member 31 is pressed toward the first member 11 to exert a restraining pressure on the first member 11. In other words, it is obvious that some sort of member is arranged on the side opposite the first intervening member 31, using the first member 11 as a reference, and due to interposition between the some sort of member and the intervening member 31, restraining pressure can be exerted on the first member 11. For example, the first member 11 may have a fifth surface 11x (refer to FIG. 3C) which surface-contacts the intervening member 31 and a sixth surface 11y (refer to FIG. 3C) on the side opposite the fifth surface 11x, and the sixth surface 11y may contact a third member. The third member may be a battery identical to the first member 11. Further, the third member may be a retention member, like the second member 21. Furthermore, the third member may be the restraining member 60, which is described later. Alternatively, the third member may be a member different from these members.

In the production method of the present disclosure, though aspects in which the first intervening member 31 and the first member 11 directly contact are illustrated, an intervening member may be further arranged between the first intervening member 31 and the first member 11.

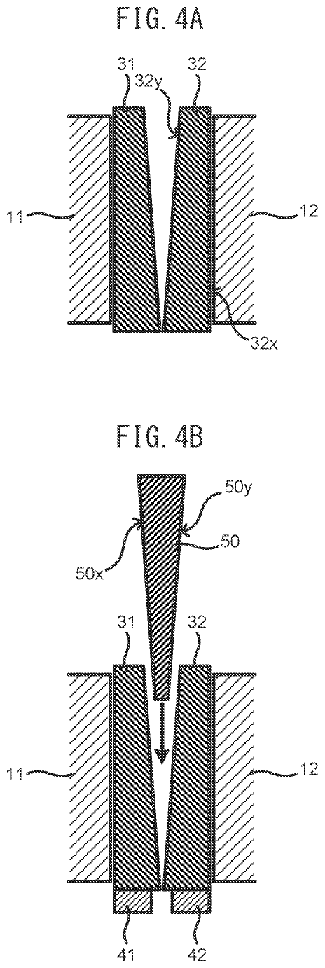

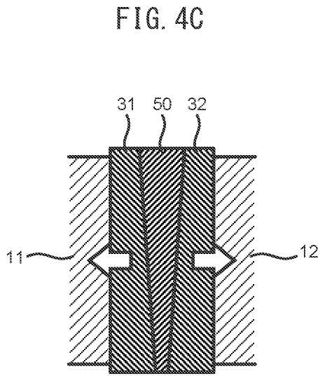

In the production method of the present disclosure, a further intervening member may be arranged between the first intervening member 31 and the second member 21. In other words, the production method of the present disclosure may comprise arranging at least the first intervening member 31 and a second intervening member 32 (refer to FIG. 4) between the first member 11 and the second member 21, and while one end of the first intervening member 31 and one end of the second intervening member 32 are pressed by at least one pressing member 41, 42, inserting tapered members 50 between the first intervening member 31 and the second intervening member 32 from the other end side of the first intervening member 31 and the other end side of the second intervening member 32, whereby the first intervening member 31 presses the first member 11, the second intervening member 32 presses the second member 21, and restraining pressure is exerted on the first member 11 and the second member 12. As a result, damage to the retention member 21, which is the second member 21, can be prevented.

### 1.7 Insertion of Tapered Member and Exertion of Restraining Pressure

In the production method of the present disclosure, the tapered member 50 is inserted between the first intervening member 31 and the second member 21, whereby the first intervening member 31 is pressed toward the first member 11 and exerts restraining pressure on the first member 11. In other words, as shown in FIGS. 1B and C, the insertion direction of the tapered member 50 and the pressing direction (restraining direction) of the first member 11 by the first intervening member 31 intersect. The insertion direction of the tapered member 50 may be the horizontal direction, may be the vertical direction, or may be a direction different from the horizontal direction and the vertical direction. As shown in FIG. 1C, the pressing direction of the first member 11 by the intervening member 31 may match the uniaxial direction described above. The insertion direction of the tapered member 50 and the pressing direction of the first member 11 by the intervening member 31 may be orthogonal. The magnitude of the restraining pressure exerted on the first member 11 is not particularly limited. It may be, for example, 1.0 MPa or more or 2.0 MPa or more, and 100 MPa or less or 50 MPa or less.

### 1.8 Concave/Convex Guide

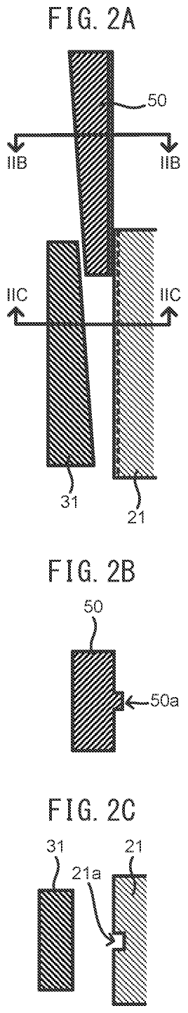

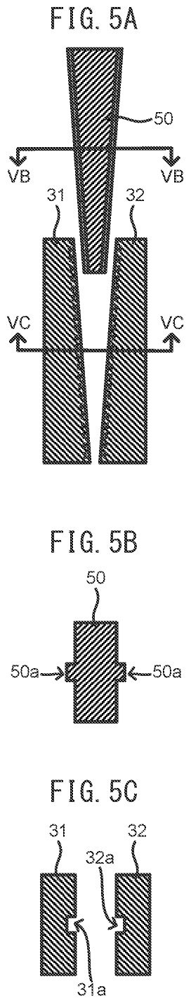

As shown in FIGS. 2A to C, by inserting the tapered member 50 along a concave/convex guide, the insertion of the tapered member 50 becomes smoother. In other words, in the production method of the present disclosure, concave/convex guides 21a, 50a may be provided between the second member 21, which is the retention member 21, and the tapered member 50, and the tapered member 50 may be inserted along the concave/convex guides 21a, 50a. Furthermore, in the production method of the present disclosure, a concave/convex guide (refer to FIGS. 5A to C) may be provided between the first intervening member 31 and the tapered member 50, and the tapered member 50 may be inserted along this concave/convex guide. The concave/convex guide may be provided along the insertion direction of the tapered member 50. The cross-sectional shape of the concave/convex guide is not particularly limited. For example, it may be a substantially rectangular cross-sectional shape, as shown in FIGS. 2B and C, may be a semi-circular cross-sectional shape, or may be a cross-sectional shape other than these. Note that though in the illustrated aspects, the tapered member 50 has a convex guide 50a and the second member 21 has a concave guide 21a, the tapered member may have a concave guide and the second member 21 may have a convex guide.

### 1.9 Battery Pack Structure

The battery pack produced by the production method of the present disclosure comprises at least the first member 11, the second member 21, the first intervening member 31, and the tapered member 50. More specifically, the battery pack according to the first aspect comprises the first member 11, the second member 21, the first intervening member 31, and the tapered member 50, wherein the first member 11 is the first battery 11, the first battery 11 comprises a first battery exterior body and an electrode body arranged in the interior of the first battery exterior body, the second member 21 is the retention member 21, the first intervening member 31 is arranged between the first member 11 and the second member 21, and the tapered member 50 is arranged between the first intervening member 31 and the second member 21. As shown in FIG. 1C, the tapered member 50 contacts the first intervening member 31, and restraining pressure is exerted on the first member 11 from the tapered member 50 via the first intervening member 31. The battery pack of the present disclosure may be configured such that the restraining pressure on the first member 11 is increased when the tapered member 50 is pushed in the direction of taper, and the restraining pressure on the first member 11 is decreased when the tapered member 50 is pulled out.

Furthermore, in the battery pack, the first intervening member 31 and the second intervening member 32 (refer to FIG. 4) may be arranged between the first member 11 and the second member 21, the tapered member 50 may be arranged between the first intervening member 31 and the second intervening member 32, whereby the tapered member 50 comes into contact with each of the first intervening member 31 and the second intervening member 32, and as a result, restraining pressure is exerted on the first member 11 from the tapered member 50 via the first intervening member 31 and restraining pressure is exerted on the second member 21 from the tapered member 50 via the second intervening member 32.

### 1.10 Application Aspect

FIGS. 3A to C show the production method of a battery pack 100 according to the application aspect. As shown in FIGS. 3A to C, the production method of the present disclosure may include arranging the first member 11, the second member 21, and the first intervening member 31 in the inside of an annular restraining member 60, and inserting the tapered member 50 to press the first member 11 and the second member 21 toward the inner surface of the restraining member 60. Note that, though not illustrated, in the aspect shown in FIGS. 3A to C, during insertion of the tapered member 50 (FIG. 3A), one end of the first intervening member 31 contacts the pressing member, whereby displacement of the first intervening member 31 can be suppressed.

### 1.10.1 Restraining Member

The restraining member 60 restrains the members arranged inside the restraining member 60 while exerting a pressure on the members. As shown in FIGS. 3A to C, the restraining member 60 may be an annular (or hoop-shaped) member which surrounds each member. The material of the restraining member 60 is not particularly limited. For example, a fiber reinforced plastic (FRP) containing fibers and resin may be wound (turned) to form a restraining member 60. Examples of fibers constituting the FRP include carbon fibers, glass fibers, and aramid fibers. Examples of the resin constituting the FRP include thermosetting resins such as epoxy resin, polyester resin, and polyamide resin. Examples of the FRP molding method include a vacuum back method, an autoclave method, a sheet winding method, a hand layup method, and a filament winding method. Such a restraining member is described in a prior application (Japanese Patent Application No. 2019-189329) by the present applicant, and the contents of the prior application are incorporated herein by way of reference.

### 1.10.2 Other Retention Members

When the first member 11 is arranged inside the restraining member 60, the first member 11 may not directly contact the inner surface of the restraining member 60. For example, as shown in FIG. 3C, the first member 11 may have a fifth surface 11x which directly contacts the intervening member 31, and a sixth surface 11y on the side opposite the fifth surface 11x, the sixth surface 11x may contact the retention member 22, and the retention member 22 may contact the restraining member 60. In other words, the first member 11 may be interposed by the retention member 22 and the first intervening member 31. The retention member 22 may be an end plate. As shown in FIGS. 3A to C, the retention member 22 may press the inner surface of the restraining member 60. When the retention member 22 presses the restraining member 60, the surface of the retention member 22 contacting the restraining member 60 consists of curved surfaces, whereby stress concentration due to pressure fluctuations can be suppressed. As shown in FIGS. 3A to C, the battery pack of the present disclosure may comprise an annular restraining member 60, a pair of endplates (second member 21 and retention member 22) arranged inside the restraining member 60, the first member 11, the first intervening member 31 and the tapered member 50 arranged between the pair of end plates, and the battery pack of the present disclosure may be configured such that when the tapered member 50 is pushed in the direction of taper, the restraining pressure on the first member 11 increases, and when the tapered member 50 is pulled out, the restraining pressure on the first member 11 decreases.

### 1.10.3 Gap

As shown in FIG. 3C, a gap 60a may be provided between the inner surface of the restraining member 60 and the first member 11. As a result, friction between the restraining member 60 and the first member 11 can be prevented, and damage to the restraining member 60 or the battery exterior body can be more easily prevented. Likewise, gaps 60a may be provided between the inner surface of the restraining member 60 and the first intervening member 31, or between the inner surface of the restraining member 60 and the tapered member 60. In FIG. 3C, the uniaxial direction described above is set as the horizontal direction, and the first member 11 may be in a state of floating in the air in the vertical direction. As shown in FIGS. 3A and B, even if the first member 11 is in a state of floating in the air in the vertical direction, by inserting the tapered member 50 from the other end side of the first intervening member 31 while one end of the first intervening member 31 is brought into contact with the pressing member, the tapered member 50 can be easily inserted in the horizontal direction.

As described above, according to the battery pack production method of the first aspect, when the tapered member 50 is inserted, the tapered member 50 does not directly contact the battery exterior body of the first battery 11. Thus, the occurrence of scratches on the battery exterior body and damage to the battery exterior body due to the sliding of the tapered member 50 can be prevented. Furthermore, by inserting the tapered member 50 from the other end side of the first intervening member 31 while one end of the first intervening member 31 is brought into contact with the pressing member, during insertion of the tapered member 50, the first intervening member 31 can be held in the insertion direction of the tapered member 50 by the pressing member 41, i.e., the first intervening member 31 can be affixed in the insertion direction of the tapered member 50, and, for example, misalignment or sliding of the first intervening member 31 with respect to the first member 11 can be prevented. In connection thereto, damage to the battery exterior body during insertion of the tapered member 50 can be suppressed.

### 2. Second Aspect

FIG. 4 shows an example of a battery pack production method according to a second aspect. As shown in FIG. 4A, the production method includes arranging the first intervening member between the first member 11 and the second member 12. The first member 11 is the first battery 11 and the first battery 11 comprises a first battery exterior body and an electrode body arranged in the interior of the first battery exterior body. Furthermore, the second member 12 is the second battery 12, and the second battery 12 comprises a second battery exterior body and an electrode body arranged in the interior of the second battery exterior body. As shown in FIGS. 4B and C, the production method includes inserting the tapered member 50 between the first intervening member 31 and the second member 12 from the other end side of the first intervening member 31 while one end of the first intervening member 31 is brought into contact with the pressing member 41, whereby the first intervening member is pressed toward the first member 11 and a restraining pressure is exerted on the first member 11.

The battery pack production method according to the second aspect differs from the battery pack production method according to the first aspect in that the tapered member 50 is inserted between the batteries 11 and 12. When the tapered member 50 is inserted between the batteries 11 and 12, an intervening member may be arranged not only on the first battery 11 side but also on the second battery 12 side.

Specifically, as shown in FIGS. 4A to C, the production method of the present disclosure may include arranging the first intervening member 31 and a second intervening member 32 between the first member 11 and the second member 12, and while pressing (holding or contacting) one end of the first intervening member 31 and one end of the second intervening member 32 with at least one pressing member 41, 42, inserting the tapered member 50 between the first intervening member 31 and the second intervening member 32 from an opposite side of the first intervening member 31 and an opposite side of the second intervening member 32, whereby the first intervening member 31 is pressed toward the first member 11 and the second intervening member 32 is pressed toward the second member 12 to exert a restraining pressure on the first member 11 and the second member 12.

### 2.1 First Member and Second Member

As in the first aspect, the first member 11 is a first battery 11. Furthermore, the second member 12 is the second battery 12 and the second battery 12 comprises a second battery exterior body and an electrode body arranged in the interior of the second battery exterior body. The structure of the second battery 12 may be identical to the structure of the first battery 11.

### 2.2 Intervening Member

As shown in FIG. 4A, in the battery pack production method according to the second aspect, in addition to the first intervening member 31, at least a second intervening member 32 may be arranged between the first member 11 and the second member 12, as described above. Like the first intervening member 31, the second intervening member 32 may be a plate-like member. The material of the second intervening member 32 is not particularly limited. For example, the second intervening member 32 may be composed of metal or ceramic. Particularly in the case in which the second intervening member 32 is made of metal, damage to the second intervening member 32 can be more easily suppressed.

As shown in FIGS. 4A to C, the second intervening member 32 may have a seventh surface 32x which surface-contacts the second member 12, and an eighth surface 32y which surface-contacts the tapered member 50. In this case, the shapes of the seventh surface 32x and the eighth surface 32y of the second intervening member 32 may be determined in accordance with the surface shape of the battery exterior body of the second member 12 or the tapered shape of the tapered member 50. For example, as shown in FIGS. 4A to C, the eighth surface 32y of the second intervening member may have an inclined surface which intersects the uniaxial direction described above and which is not perpendicular to the uniaxial direction, and the inclined surface may have an inclination corresponding to the tapered shape of the tapered member 50.

As shown in FIGS. 4A to C, the first intervening member 31 and the second intervening member 32 may be members having substantially identical shapes. Specifically, by preparing two first intervening members 31 and turning one over, it can be used as the second intervening member 32. In other words, as shown in FIGS. 4A to C, they may be substantially symmetrical. When the first intervening member 31 and the second intervening member 32 are symmetrical, insertion of the tapered member 50 between the first intervening member 31 and the second intervening member 32 becomes easy.

### 2.3 Pressing Member

As shown in FIG. 4B, in the battery pack production method according to the second aspect, while one end of the intervening member 31 is brought into contact with the pressing member 41, a tapered member 50 is inserted between the first intervening member 31 and the second member 21 from the other end side of the first intervening member 31. Furthermore, while one end of the second intervening member 32 is brought into contact with the pressing member 42, a tapered member 50 may be inserted between the second intervening member 32 and the first member 11 from the other end side of the second intervening member 32 (and as a result, a tapered member 50 is inserted between the first intervening member 31 and the second intervening member 32). By inserting a tapered member 50 between the intervening members 31, 32 from the other end sides of the intervening members 31, 32 while the ends of the intervening members 31, 32 are brought into contact with the pressing members 41, 42, during insertion of the tapered member 50, the intervening members 31, 32 can be held in the insertion direction of the tapered member 50 by the pressing members 41, 42, and specifically, the intervening members 31, 32 can be affixed in the insertion direction of the tapered member 50, whereby, for example, displacement or sliding of the first intervening member 31 with respect to the first member 11 can be prevented and displacement or sliding of the second intervening member 32 with respect to the second member 12 can be prevented.

Though an aspect in which the pressing members 41, 42 contact only the intervening members 31, 32 is illustrated in FIG. 4B, in addition to the intervening members 31, 32, the pressing members 41, 42 may contact other members such as the first member 11 and the second member 21. Furthermore, when insertion of the tapered member 50 is complete, the tip of the tapered member 50 may contact the pressing members 41, 42. Furthermore, the insertion of the tapered member 50 may be stopped by bringing the tip of the tapered member 50 into contact with the pressing member 41, 42.

Though an aspect in which the pressing member 41 and the pressing member 42 are separate members is illustrated in FIG. 4B, the pressing member 41 and the pressing member 42 may be integral. Furthermore, in addition to the pressing members 41, 42, other pressing members may be provided.

As in the first aspect, the pressing members 41, 42 may not constitute the battery pack. In other words, the pressing members 41, 42 may be some sort of members on the production equipment side. For example, the pressing members 41, 42 may be jigs which are separate from the battery pack.

### 2.4 Tapered Member

The tapered member 50 may be identical to that in the first aspect. As described above, the tapered member 50 has a tapered shape corresponding to the surface shapes of the intervening members 31, 32. For example, as the tapered member 50, a plate-shaped member having a wedge-shaped cross section in the thickness direction can be used. As shown in FIGS. 4B and C, the tapered member 50 may have a third surface 50x which surface-contacts the first intervening member 31 and a fourth surface 50y which surface-contacts the second intervening member 32. The third surface 50x and the fourth surface 50y of the tapered member 50 may be flat, may be curved, or may be a combination of flat and curved, but particularly in the case in which the surfaces are flat, insertion of the tapered member 50 is smoother.

As described above, in the production method of the present disclosure, when the coefficient of friction between the first intervening member 31 and the tapered member 50 is less than the coefficient of friction between the first battery exterior body of the first battery 11 and the first intervening member 31, insertion of the tapered member 50 becomes smoother, and displacement or sliding of the first intervening member 31 with respect to the first member 11 can be more easily prevented. The same applies on the second intervening member 32 side. In other words, when the coefficient of friction between the second intervening member 32 and the tapered member 50 is less than the coefficient of friction between the second battery exterior body of the second battery 12 and the second intervening member 32, insertion of the tapered member 50 becomes smoother, and displacement or sliding of the second intervening member 32 with respect to the second member 12 can be more easily prevented.

2.5 Other Members

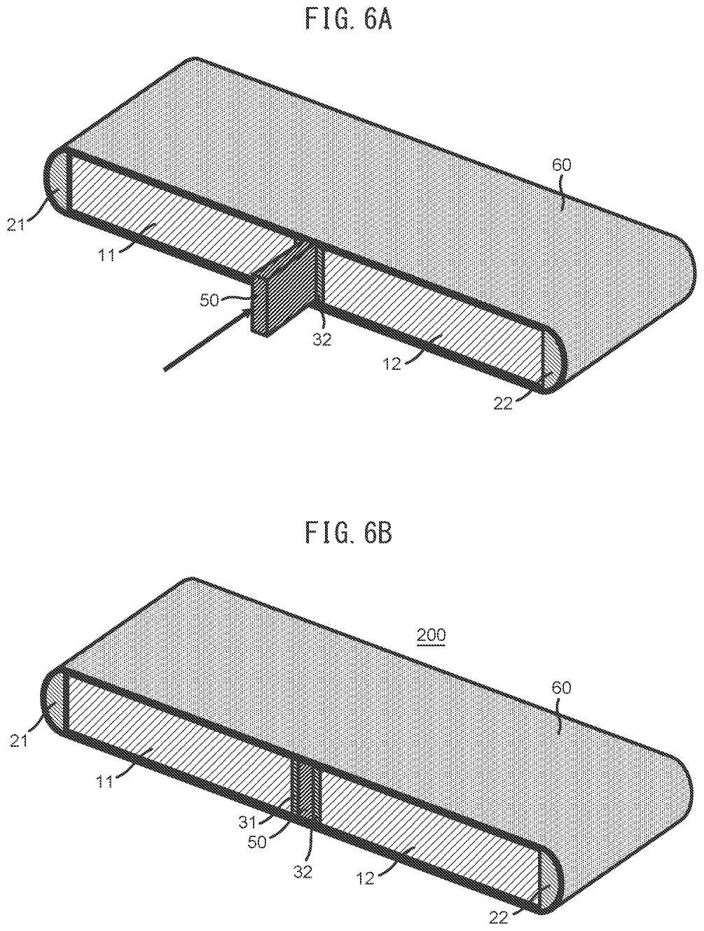

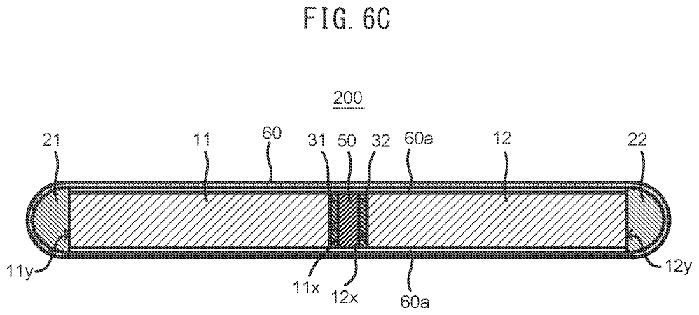

In the aspect illustrated in FIGS. 4A to C, the first intervening member 31 is pressed toward the first member 11, whereby restraining pressure is exerted on the first member 11, and the second intervening member 32 is pressed toward the second member 12, whereby restraining pressure is exerted on the second member. In other words, it is obvious that some sort of member is arranged on the side opposite the first intervening member 31, using the first member 11 as a reference, and it is obvious that some sort of member is arranged on the side opposite the second intervening member 32, using the second member 12 as a reference. Restraining pressure is exerted on the first member 11 as a result of interposition between this other member and the first intervening member 31, and restraining pressure is exerted on the second member 12 as a result of interposition between this other member and the second intervening member 32. For example, the first member 11 may have a fifth surface 11x which surface-contacts the first intervening member 31 and a sixth surface 11y on the side opposite the fifth surface 11x, and the sixth surface 11y may contact a third member (refer to FIG. 6C). Furthermore, the second member 12 may have a ninth surface 12x which surface-contacts the second intervening member 32 and a tenth surface 12y on the side opposite the ninth surface 12x, and the tenth surface 12y may contact a fourth member (refer to FIG. 6C). The third member and the fourth member may be batteries identical to the first member 11 and the second member 12. Further, the third member and the fourth member may be retention members. Furthermore, the third member and the fourth member may be restraining members 60. Alternatively, the third member and the fourth member may be members different from these.

In the production method of the present disclosure, though an aspect in which the first intervening member 31 and the first member 11 directly contact and the second intervening member 32 and the second member 12 directly contact is illustrated, an further intervening member may be arranged between the first intervening member 31 and the first member 11 and a further intervening member may be arranged between the second intervening member 32 and the second member 12.

### 2.6 Insertion of Tapered Member and Exertion of Restraining Pressure

In the production method of the present disclosure, as illustrated in FIGS. 4B and C, the insertion direction of the tapered member 50 and the pressing directions (restraining directions) of the first member 11 and the second member 12 by the intervening member 31, 32 may intersect. The insertion direction of the tapered member 50 may be the horizontal direction, may be the vertical direction, or may be a direction different from the horizontal direction and the vertical direction. As shown in FIG. 4C, the direction of the restraining pressure may match the uniaxial direction described above. The insertion direction of the tapered member 50 and the pressing directions of the first member 11 and the second member 12 by the intervening members 31, 32 may be orthogonal. The magnitude of the restraining pressure exerted on the second member 12 is not particularly limited. For example, it may be 1.0 MPa or more or may be 2.0 MPa or more, and may be 100 MPa or less or may be 50 MPa or less.

### 2.7 Concave/Convex Guide

As described above, by inserting the tapered member along a concave/convex guide, the insertion of the tapered member 50 becomes smoother. In other words, as illustrated in FIGS. 5A to C, in the battery pack production method according to the second aspect, a concave/convex guide may be provided at least one of between the first intervening member 31 and the tapered member 50 and between the second intervening member 32 and the tapered member 50, and the tapered member 50 may be inserted along the concave/convex guide. The concave/convex guide may be provided along the insertion direction of the tapered member 50. The cross-sectional shape of the concave/convex guide is not particular limited. For example, a substantially rectangular cross-sectional shape, as illustrated in FIGS. 5B and C, may be adopted, a semicircular shape may be adopted, or a cross-sectional shape other than these shapes may be adopted. Note that though the tapered member 50 has a convex guide 50a and the intervening members 31, 32 have concave guides 31a, 32a in the illustrated aspect, the tapered member 50 may have a concave guide, and the intervening members 31, 32 may have convex guides.

### 2.8 Battery Pack Structure

The battery pack according to the second aspect comprises the first member 11, the second member 12, the first intervening member 31, and the tapered member 50, the first member 11 is the first battery 11, the first battery 11 comprises a first battery exterior body and an electrode body arranged in the interior of the first battery exterior body, the second member 12 is the second battery 12, the second battery 12 comprises a second battery exterior body and an electrode body arranged in the interior of the second battery exterior body, the first intervening member 31 is arranged between the first member 11 and the second member 12, and the tapered member 50 is arranged between the first intervening member 31 and the second member 12. As shown in FIG. 4C, the tapered member 50 contacts the first intervening member 31, whereby restraining pressure is exerted on the first member 11 from the tapered member 50 via the first intervening member 31.

Furthermore, as shown in FIG. 4C, in the battery pack, the first intervening member 31 and the second intervening member 32 may be arranged between the first member 11 and the second member 12, a tapered member 50 may be arranged between the first intervening member 31 and the second intervening member 32, the tapered member 50 may contact each of the first intervening member 31 and the second intervening member 32, the first intervening member 31 may contact the first member, and the second intervening member 32 may contact the second member 12, whereby restraining pressure is exerted on the first member 11 and the second member 12.

### 2.9 Application Aspect

FIGS. 6A to C show a battery pack 200 production method according to an application aspect. As shown in FIGS. 6A to C, the production method according to the present disclosure may include arranging the first member 11, the second member 12, and at least one intervening member 31, 32 in an annular restraining member and inserting the tapered member 60 to press the first member 11 and the second member 21 toward the inner surface of the restraining member 60. Note that in the aspect illustrated in FIGS. 6A to C, during insertion of the tapered member 50 (FIG. 6A), by bringing one end of the intervening members 31, 32 into contact with the pressing member, displacement or the like of the intervening members 31, 32 can be suppressed.

The battery pack illustrated in FIGS. 6A to C, is identical to the battery pack illustrated in FIGS. 3A to C except that the insertion position of the tapered member 50 is not between the first battery 11 and the retention member 21 but between the first battery 11 and the second battery 12.

As described above, according to the battery pack production method according to the second aspect, when the tapered member 50 is inserted, the tapered member 50 does not directly contact the battery exterior body of the first battery 11. Thus, the occurrence of scratches on the battery exterior body and damage to the battery exterior body due to the sliding of the tapered member 50 can be prevented. Furthermore, by inserting the tapered member 50 from the other side end of the intervening member 31 while one end of the intervening member 31 is brought into contact with the pressing member, during insertion of the tapered member 50, the intervening member 31 can be held in the insertion direction of the tapered member 50 by the pressing member 41, and in other words, the intervening member 31 can be affixed in the insertion direction of the tapered member 50, whereby, for example, displacement or sliding of the intervening member 30 with respect to the first member 11 can be prevented. In connection thereto, damage to the battery exterior body during insertion of the tapered member 50 can be suppressed. The same is true on the second member (second battery) 12 side.

### 3. Supplement

Though the first aspect and the second aspect are illustrated separately in the above description, in the battery pack production method and the battery pack of the present disclosure, the first aspect and the second aspect may be combined. Specifically, a tapered member may be inserted between the first battery and the retention member, and a tapered member may be inserted between the first battery and the second battery.

Furthermore, though an aspect in which only one tapered member is inserted in the battery pack is illustrated in the above description, a plurality of tapered members may be inserted in the battery pack. In any case, by arranging an intervening member between the tapered member and the battery exterior body, damage to the battery exterior body can be prevented. Furthermore, by bringing the pressing member into contact with one end of the intervening member during insertion of the tapered member, displacement or sliding of the intervening member with respect to the battery exterior body can be prevented, and in connection thereto, damage to the battery exterior body can be prevented.

### INDUSTRIAL APPLICABILITY

The battery pack of the present disclosure is suitable as, for example, a large power supply for mounting on automobiles.

### REFERENCE SIGNS LIST

11 first member (first battery)
12 second member (second battery)
21 second member (retention member)
22 retention member
31 intervening member (first intervening member)
32 second intervening member
41 pressing member
42 pressing member
50 tapered member
60 restraining member
60a gap
100 battery pack
200 battery pack

1. A production method for a battery pack, comprising:
arranging a first intervening member between a first member and a second member, wherein the first member is a first battery, the first battery comprises a first battery exterior body and an electrode body arranged in an interior of the first battery exterior body, the second member is a retention member or a second battery, the second battery comprises a second battery exterior body and an electrode body arranged in an interior of the second battery exterior body, and
while one end of the first intervening member is brought into contact with a pressing member, inserting a tapered member between the first intervening member and the second member from an opposite end side of the first intervening member to press the first intervening member toward the first member and exert a restraining pressure on the first member.

2. The production method according to claim 1, comprising:
arranging the first intervening member and a second intervening member between the first member and the second member, and
while pressing one end of the first intervening member and one end of the second intervening member with at least one pressing member, inserting the tapered member between the first intervening member and the second intervening member from an opposite side of the first intervening member and an opposite side of the second intervening member to press the first intervening member toward the first member and press the second intervening member toward the second member to exert a restraining pressure on the first member and the second member.

3. The production method according to claim 1, wherein
the second member is the retention member,
a concave/convex guide is provided between the second member and the tapered member, and
the tapered member is inserted along the concave/convex guide.

4. The production method according to claim 1, wherein
a concave/convex guide is provided between the first intervening member and the tapered member, and
the tapered member is inserted along the concave/convex guide.

5. The production method according to claim 1, wherein
the coefficient of friction between the first intervening member and the tapered member is less than the coefficient of friction between the first battery exterior body and the first intervening member.

6. The production method according to claim 1, comprising:
arranging the first member, the second member, and the first intervening member inside an annular restraining member, and
pressing the first member and the second member toward an inner surface of the restraining member by insertion of the tapered member.

7. The production method according to claim 1, wherein
the first battery and the second battery are solid-state batteries.

8. A battery pack, comprising a first member, a second member, a first intervening member, and a tapered member, wherein
the first member is a first battery,
the first battery comprises a first battery exterior body and an electrode body arranged in an interior of the first battery exterior body,
the second member is a retention member or a second battery,
the second battery comprises a second battery exterior body and an electrode body arranged in an interior of the second battery exterior body,
the first intervening member is arranged between the first member and the second member,
the tapered member is arranged between the first intervening member and the second member, and
the tapered member contacts the first intervening member, and a restraining pressure is exerted onto the first member from the tapered member via the first intervening member.

9. The battery pack according to claim 8, wherein
the first intervening member and a second intervening member are arranged between the first member and the second member,
the tapered member is arranged between the first intervening member and the second intervening member, and
the tapered member contacts the first intervening member and the second intervening member, a restraining pressure is exerted onto the first member from the tapered member via the first intervening member, and a restraining pressure is exerted onto the second member from the tapered member via the second intervening member.

10. The battery pack according to claim 8, wherein
the second member is the retention member, and
a concave/convex guide is provided between the second member and the tapered member.

11. The battery pack according to claim 8, wherein
a concave/convex guide is provided between the first intervening member and the tapered member.

12. The battery pack according to claim 8, wherein
the coefficient of friction between the first intervening member and the tapered member is less than the coefficient of friction between the first battery exterior body and the first intervening member.

13. The battery pack according to claim 8, comprising an annular restraining member, wherein
the first member, the second member, and the first intervening member are arranged inside the restraining member, and
the first member and the second member are pressed toward an inner surface of the restraining member.

14. The battery pack according to claim 8, wherein
the first battery and the second battery are solid-state batteries.
